(19) United States
(12) Patent Application Publication
(10) Pub. No.: US 2021/0035170 A1
(43) Pub. Date: Feb. 4, 2021

(54) QR Code Based Review System

(71) Applicants: Nicole Guest, Berkeley, CA (US); Jackie Underwood, Berkeley, CA (US)

(72) Inventors: Nicole Guest, Berkeley, CA (US); Jackie Underwood, Berkeley, CA (US)

(21) Appl. No.: 16/524,196

(22) Filed: Jul. 29, 2019

(51) Int. Cl. G06Q 30/02; G06K 7/14; G06K 19/06; B42D 15/02

(52) U.S. Cl. CPC G06Q 30/0282; B42D 15/02; G06K 19/06178; G06K 7/1417

(57) ABSTRACT

Systems and methods are disclosed herein for overcoming the limitations of placing QR code onto a business cards or paper and to be scannable by a smartphone camera and a method for utilizing a QR code to receive instant reviews. The method allows customer feedback acquisition and processing system by printing QR code on a business card or paper and when required the code can be scanned to leave an instant review to the destination website. The proposed method may also be used with packages and invoices.

### BACKGROUND

### Field of the Invention

The present invention relates generally to information acquisition and processing systems and, more particularly, to a customer feedback acquisition and processing system for use in obtaining, organizing and analyzing customer feedback related to products and services by utilizing QR code to receive face to face instant reviews.

### Description of the Related Art

QR code has come to us from Japan where they are very common. QR is short for Quick Response (they can be read quickly by a cell phone). They are used to take a piece of information from a transitory media and put it in to the users' cell phone. QR Codes are proposed to be seen soon in a magazine advert, on a billboard, a web page or even on someone's t-shirt. Once it is in users' cell phone, it may give details about that business (allowing users to search for nearby locations), or details about the person wearing the t-shirt, can show a URL which can be clicked to see a trailer for a movie, or it may give a coupon which can be used in a local outlet.

The reason why they are more useful than a standard barcode is that they can store (and digitally present) much more data, including URL links, geo coordinates, and text. The other key feature of QR Codes is that instead of requiring a chunky hand-held scanner to scan them, many modern cell phones can scan them by just installing an application.

2D barcodes were created to address the ID barcode limitation on the encoded data size. The most popular version of 2D barcodes is the QR code.

Actually, the most common use of QR codes has been to encode Uniform Resource Locators(URLs), such as website addresses. Such QR codes provides consumers with quick and easy way to visits a company's website, without having to memorize, write down or manually type a URL in mobile devices. Consumers may take a picture of the QR code, using a camera embedded in the smartphone, and may utilize a smartphone application to automatically translate the QR code into URL. Smartphone Application may then launch a browser pointed to the URL. Modern Smartphone cameras can detect QR codes automatically.

There are multiple inventions that have been enlisted in prior art which are defining the new system and procedures for the effective utilization of QR codes. For instance, System and Method for Using Intelligent Codes to Add a Stored-Value Card to an Electronic Wallet is a patent issued to Blackhawk Network Inc bearing patent no 2,013,030,4642A1. The method comprises of receiving a request to add a stored-value card to an electronic wallet via interpreting an intelligent code which directs a user to a URL for an electronic wallet website; prompting a user for credentials to enter the electronic wallet website; determining whether the stored-value card already exists in the electronic wallet; and adding the stored-value card to the electronic wallet. A system comprises a computer device to receive a request to add a stored-value card to an electronic wallet via interpreting an intelligent code which directs a user to a URL for an electronic wallet website; to prompt a user for credentials to enter the electronic wallet website, to determine possession of the stored-value card, to determine whether the stored-value card already exists in the electronic wallet, and to add the stored-value card to the electronic wallet.

Similarly, another invention bearing US Patent 2,013,025,6403A1 issued to Wendy MacKinnon Keith is a system and Method for Facilitating Secure Self Payment Transactions of Retail Goods. The disclosed herein are various embodiments for systems and methods for self-payment and verification of the purchase of retail goods and services. According to an embodiment of the invention, a method for verifying the purchase using a mobile electronic device in wireless communication with a payment verification system and a code generating system is provided, the method comprising the steps of: receiving from a consumer information identifying an item for purchase; receiving from a consumer information identifying payment means for purchasing the item for purchase; processing the information identifying the item for purchase and information identifying payment means and generating a unique QR code indicating a purchase of the item; sending the unique QR code to a mobile device for display by a consumer to the vendor of the item for purchase.

A US Patent 2,014,014,308,9A1 issued to Blackhawk Network Inc depicts a system and Method for Using Intelligent Codes in Conjunction with Stored-Value Cards. The invention discloses a system and method of transacting a prepaid product with an electronic mobile device that is used to electronically interface with a code, such as a QR code, bar code, RF signal or NFC signal, representing a prepaid product. The codes of multiple prepaid products of multiple prepaid product providers are grouped together on a single structure or in a single computer displayed in a shopping area. The electronic mobile device subsequently electronically interfaces with a point of sale device after electronically interfacing with said code to provide prepaid product information.

A systems and methods for using quick response codes to activate software applications bearing US Patent US20130239104A1 is issued to Symantec Corp. The invention discloses a computer-implemented method for facilitating access to shared resources within computer clusters may include (1) identifying a quick response code captured by at least one computing system, (2) identifying information encoded in the quick response code captured by the computing system, (3) determining that the information encoded in the quick response code contains an activation key that facilitates activation of a software application, then (4) applying, in response to this determination, the activation key to the software application in order to activate the software application without requiring a user of the software application to manually enter the activation key. Various other methods, systems, and computer-readable media are also disclosed.

A system and method for applying a digital signature and authenticating physical documents bearing US Patent U.S. Pat. No. 9,369,287 B1 is issued to Seyed Amin Ghorashi Sarvestani. The patent discloses a system and a method for generating and authenticating a digital signature on a physical document. The system and method includes the use of a document having a code embedded therein (e.g., a Radio Frequency Identification Code and/or a Near Field Communication Code), a first user computing device having a first user application software and a code reader, a second user computing device having a second user application software and a code reader, a printer for printing a digital signature on the document, and a main application server for generating, encrypting and authenticating a digital signature, the data integrity of the document and status of the document.

Another patent proposes a System and method for processing gift cards using scannable code. A method is disclosed which blends the use of scannable codes such as a quick response (QR) codes and processing virtual gift cards. The system receives from a first device associated with a giver at a first time, a first visual scan of a code and data from a giver to identify a recipient and other parameter with a gift. The system receives from a second device associated with a recipient a second visual scan of the code. The system presents at least a second portion of data on the second device and then establishes a policy based on the data that causes the system to monitor purchases using the recipient payment account that existed prior to the first time for a qualifying purchase upon which the system applies the gift according to the policy.

To be scannable by a smartphone camera the QR code size should be big enough to cover the substantial proportion of the screen, so depending on the size of the QR code, the distance to the camera lens, the magnification factor, and the camera sensor resolution, QR codes may be scanned by average smartphones and utilized. However, looking at prior art very less advancement of QR codes has been achieved in day to day business processes.

There are also multiple inventions regarding customer feedback evaluation system. For instance, a system and method for automated customer feedback bearing U.S. Pat. No. 7,877,265 B2 is issued to AT&T Intellectual Property I LP. The patent discloses a system and method for automated customer feedback allows for automatically collecting and analyzing customer feedback data regarding customer satisfaction and customer task completion with respect to self-service applications and live agents. When contacting a customer service center, customers provide one or more customer tasks. The customers are routed within the customer service center based on the customer task and/or one or more customer characteristics. While interacting with the customer service center, the customers are automatically asked one or more specific survey questions relating to the customers' interaction with the customer service center and the customers' satisfaction levels. The customers provide one or more survey responses to the survey questions. The survey responses are recorded and analyzed in order to modify and update the customer service center and the survey questions in order to increase customer satisfaction and increase customer task completion.

Another patent on Customer feedback acquisition and processing system bearing U.S. Pat. No. 6,510,427 B1 is issued to Ameritech Properties Inc. The patent discloses a customer feedback acquisition and processing system is disclosed. Customer feedback, which may optionally include voice signals, is captured and stored in a database. The database can be searched to develop a subset of records pertaining to an area of interest. A data mining tool can then be used on the subset to identify trend(s) in the customer feedback records. The database tool assigns relevance scores to each word (“concept”) in one or more fields of the records in the subset. It then combines the concepts and develops new relevance scores for the combined concepts to identify trend(s) in the customer feedback records.

A Global customer satisfaction system bearing U.S. Pat. No. 7,996,252 B2 is issued to Global Customer Satisfaction System LLC. The patent discloses a global customer satisfaction system includes point-of-sale customer feedback terminals for receiving in-store customer feedback including satisfaction ratings and other customer feedback regarding participating vendors as the customer pays for purchases. The system also includes post-sale customer feedback terminals for receiving more detailed customer feedback regarding the vendors from members after the sales have been completed. The system also includes an aggregation and dissemination system for combining the ratings received form customers into global customer satisfaction ratings for participating vendors and disseminating the customer satisfaction information through customer satisfaction qualified directories, which are organized or searchable by geographical, type of product or service offered by the participating vendors, and other factors.

Another system and method for providing a unified customer feedback solution bearing US patent 2,007,005,5694A1 is issued to Customer Feedback Solutions Inc. The patent discloses a method for providing a system for allowing businesses to manage substantially all of their customer relations and feedback on a computer network via a Customer Feedback System, where the method includes providing a software framework supporting multiple client modules, enabling/disabling client modules individually, maintaining a set of client modules, customizing a user interface, and processing user requests and/or feedback data for a client.

Another method and system for automatically generating questions and receiving customer feedback for each transaction bearing US patent 2,001,003,7206A1 is issued to VIVONET ACQUISITION Ltd. The patent discloses a method and system for automatically generating survey questions, receiving customer response feedback, and associating the feedback with purchase information. Purchase information is stored at the time of purchase and the customer is given an identifier for the purchase. Then, at the customer's convenience, either at the point of sale or through a networked computer, the customer can provide responses to questions that are automatically generated based on the items purchased, preferences and previous feedback. Survey questions are displayed, and feedback responses are stored, analyzed and associated with purchase information in real time.

There are multiple solutions that have been presented in prior art. Within the last decade the advancement in feedback system has been greatly reshaped. However, looking at the prior art in a similar field, the improvement in effective utilization of technology and user-friendliness is greatly limited. The current invention proposes a hands-on tool that allows a user to provide a system and method to apply QR codes to business cards or any type of paper, and then achieve instant reviews. The proposed invention allows a user to carry around a wallet-sized QR code which will automatically link the person scanning it to a review page. This aims to provide convenience to the average person as they can provide their feedback on the spot and this can be achieved on very timely basis which cannot be more than 30 seconds. QR codes are generally used to direct people to websites. We are directing people to rating pages, straight from their smartphones, for faster and guaranteed reviews.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of generating and placing Quick Response (QR) matrix barcodes on business cards.

It is further the objective of the invention to place the QR code on small plain surface on business card or any sort of paper effectively, so scanning and decoding of algorithms can be effectively achieved.

It is also the objective of the invention to provide a method to print and then detect a bar code printed with ink onto a small business card or paper.

It is moreover the objective of the invention to gather business reviews instantly and effectively.

It is further the objective of the invention to provide companies an effective medium to gather on spot, instant and quality feedback from the customers.

It is also the objective of the invention to provide a cost-effective feedback system which eliminates the need of separate paperwork, feedback systems installations, call centers and need of additional workforce to manage and entertain customers feedback.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

FIG. 1 is an illustrative representation explaining the process of use in accordance with an embodiment of the present invention.

FIG. 2 is a block diagram showing the flow of process as per exemplary embodiments of the invention.

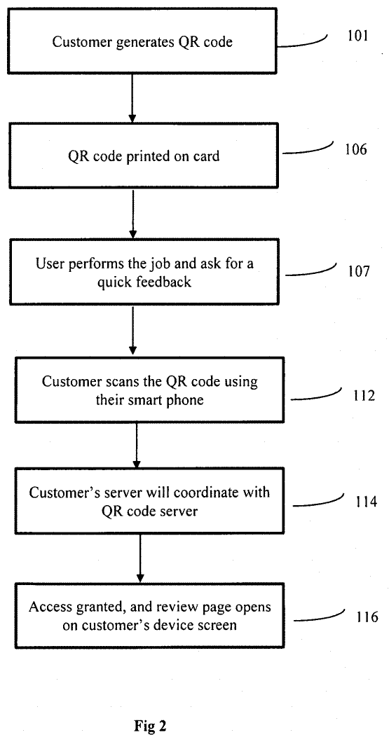

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment discloses a QR code utilization for business purposes. Nowadays QR codes are found everywhere including billboards, packaging, magazines etc. However, utilization of QR codes for business purposes is still on preliminary stage.

Typically the format of QR code is a square matrix of black and white or any other color in form of small squares, surrounded by a white border. It can be 21 by 21, 25 by 25 and bigger. Usually, format 25 is enough to encode a short URL on a 7% error correction level. Although format 21 is better in terms of real-life conditions scannability, they can only encode a limited amount of combinations that may not be enough for practical use.

The current invention proposes to introduce a practical approach to create scannable QR codes on small plain surfaces typically referring here to business cards or paper. This allows the sales representatives or business people to gather the customers feedback at the spot. Utilizing bar code in this way intents to reduce the normal time period to gather feedback, is more accurate and trustworthy and is very convenient to use for both of the parties.

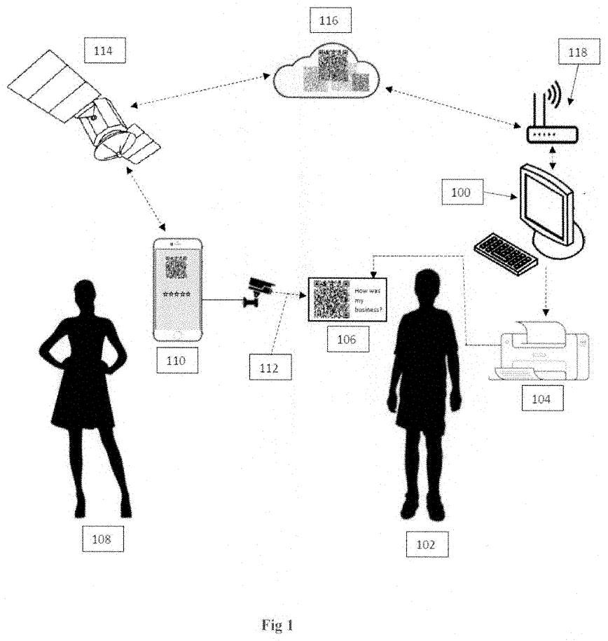

FIG. 1 is an illustrative representation showing a line drawn connection diagram to help explain the process of use in accordance with an embodiment of the present invention. This connection diagram and description will provide the process of use. The first step in this process involves the user creating their custom QR code through the website portal on the computer (100). Once the desired QR code and card design has been achieved, the user (102) would then produce the card (104) through printing or other methods. Once that process is complete, the user may then place the card (106) safely in their wallet and go about their day. As an example, the user has just completed a paint job on a client's (108) car. Before the client leaves, the user may ask if they wouldn't mind taking 30 seconds out of their day to scan a QR code and leave a quick review. The convenience of this removes the need to visit a specific website, look for the reviews tab, etc. making the client much more obliged to leave a review. The client would then agree to scan the code and take out their phone (110). Using a QR compatible camera on their phone, they would scan the visible QR code (112). The speed of accessing the review page depends on the carrier at that time. The phone pings a signal to the network provider (114). The network provider pings the server (116) of the company that stores the QR code data. The server confirms the QR code by checking the database for new QR codes received from different users and confirms the specific one sent from the user's network (118), pings the network provider back and the page is accessed on the phone. This process of course, happens in milliseconds. This method can be used for a wallet sized business card, a package, invoice or other methods of delivery.

For clarification, the main scope of this document is to protect the instant server/channel created for reviewing, rating, comments, testimonials of a person/business/product/service through a method of QR code printed on a business card or package.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A communications method comprising:
a) Business card or paper with QR code;
b) presenting a business card or paper to an optical sensor preferably of a customer;
c) the optical sensor producing image data from the business card corresponding to a person/product/service;
d) Separating from the image data QR based digital information;
e) using said discerned digital information to access a remote data store;
f) creating a direct link to the host server to receive feedback; and
g) establishing communication with the person and providing them status of updated information;

2. The Method of claim 1, further comprising of providing a system configured to produce and print QR codes on business cards or paper, the customer smart device's reader adapted to take an image of the two-dimensional code; and the application configured to decode the encoded text, normally a short URL, based on the image of the two-dimensional code taken by the reader.
a) The method of claim II, wherein the reader is a mobile phone having a digital camera;
b) The method of claim II, wherein the application is configured to enable a user to decode the encoded short URL and navigate on a browser to the destination URL and launching the feedback page;
c) The method of claim II, wherein the QR code encodes a short URL with the minimum possible characters to allow sufficient combinations to make each code unique;
d) The method of claim II, wherein the short URL key is comprised of a human-readable case-insensitive set of characters.
